(19) United States
(12) Patent Application Publication
(10) Pub. No.: US 2008/0030471 A1
(43) Pub. Date: Feb. 7, 2008

(54) Mouse having a receiving and positioning structure

(76) Inventor: Cheng-Cheng Wu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,319

(22) Filed: Jan. 16, 2007

(30) Foreign Application Priority Data
Aug. 4, 2006 (TW) 95213777

(51) Int. Cl. G09G 5/08

(52) U.S. Cl. 345/163

(57) ABSTRACT

A mouse having a receiving and positioning structure comprises a mouse body, a cord, and a connector. The surface of the mouse body has a first positioning portion. The cord extends from the mouse body. The connector is disposed at the distal end of the cord. The surface of the connector has a second positioning portion corresponding to the first positioning portion. When a user finishes using the mouse and disconnects the connector from a socket of the computer, the first positioning portion of the mouse body and the second positioning portion of the connector can be combined to position the connector on the surface of the mouse body. The mouse body and the connector at both ends of the cord can thus be combined together to facilitate the portability or storage of the mouse.

### BACKGROUND OF THE INVENTION

1. Field of the Invention

The present invention relates to a mouse having a receiving and positioning structure and, more particularly, to a mouse having a receiving and positioning structure, in which the mouse body and the connector at both ends of the cord are combined together to reduce the space occupied by the mouse when not in use so as to facilitate its portability and storage.

2. Description of Related Art

With the progress and development of science and technology, computers have become an indispensable part of everyday life of people. Input devices are essential peripherals for computers. In order to match the ever-evolving functions of computer, input devices (e.g., mouse, keyboard, and so on) have been continually developed to be more practical. Except for when a user is inputting large amount of text, the mouse is used much more frequently than the keyboard. Because mice are flexible and can be manipulated easily, they can assist and replace bulky keyboards. Especially in the manipulation of multimedia and the Internet, mice have their irreplaceable roles.

A commercially available wired mouse primarily includes a mouse body, a cord, and a connector. The cord extends from the mouse body. The connector is connected with the cord and disposed at the distal end of the cord.

When using the above mouse, a user can insert the connector in a computer to connect the mouse body and the computer via the cord. By operating the mouse body, commands can be input to the computer to control the operation of the computer.

The development of electronic technologies always follows the requirements of user. Recently, users have paid much attention to the portability of mouse. In order to facilitate the portability or storage of mice when not in use, the design of today's mice has focused on the compactness of the mouse body. However, for the above conventional mouse structure, no matter how much the size of the mouse body is shrunk, the storage of the cord and the connector that are connected together are the most difficult. Moreover, the connector and the cord cannot be integrally stored with the mouse body and are subject to damage because they cannot be combined with the mouse body. Furthermore, the conventional mouse occupies more space, and cannot be stored in a narrower space or arbitrarily placed in a coat pocket.

Accordingly, the present invention aims to propose a mouse having a receiving and positioning structure to solve the above problems in the prior art.

### SUMMARY OF THE INVENTION

A primary object of the present invention is to provide a mouse having a receiving and positioning structure, in which a mouse body and a connector at both ends of a cord are combined together to reduce the space occupied by the mouse when not in use so as to facilitate the portability or storage of the mouse.

To achieve the above object, the present invention provides a mouse having a receiving and positioning structure, which comprises a mouse body, a cord, and a connector. A first positioning portion is disposed on the surface of the mouse body. The cord extends from the mouse body. The connector is disposed at the distal end of the cord. A second positioning portion corresponding to the first positioning portion is disposed on the surface of the connector.

When a user finishes using the mouse and disconnects the connector from a socket of a computer, the first positioning portion of the mouse body and the second positioning portion of the connector can be combined to position the connector on the surface of the mouse body. The mouse body and the connector at both ends of the cord can thus be combined together to facilitate portability or storage of the mouse.

### BRIEF DESCRIPTION OF THE DRAWINGS

The various objects and advantages of the present invention will be more readily understood from the following detailed description when read in conjunction with the appended drawing, in which:

FIG. 1 is a perspective view according to a first embodiment of the present invention;

FIG. 2 is a perspective assembly view according to the first embodiment of the present invention;

FIG. 3 is a perspective view according to a second embodiment of the present invention;

FIG. 4 is a perspective assembly view according to the second embodiment of the present invention;

FIG. 5 is a perspective view according to a third embodiment of the present invention;

FIG. 6 is a perspective assembly view according to the third embodiment of the present invention.

### DETAILED DESCRIPTION OF THE PREFERRED EMBODIMENTS

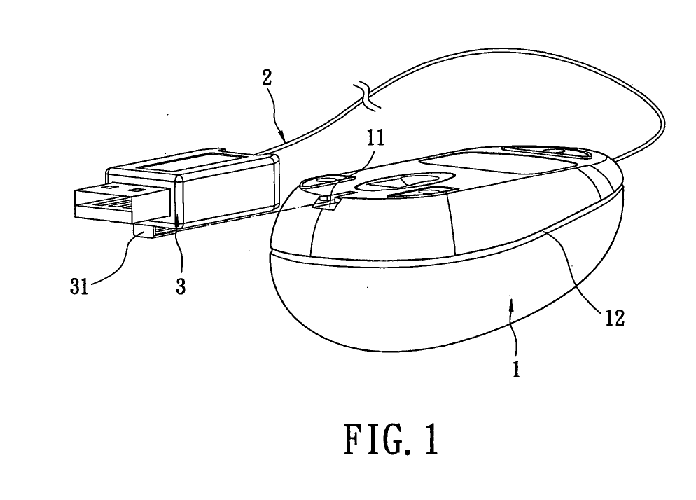

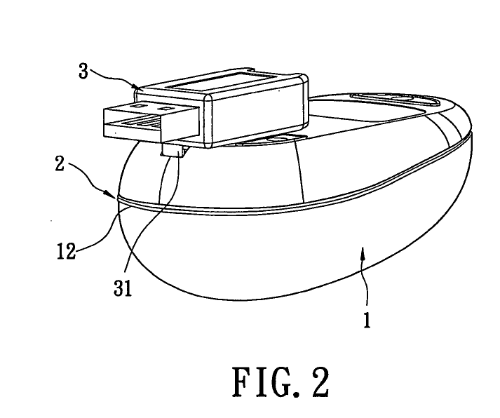

FIGS. 1 and 2 show a mouse having a receiving and positioning structure of the present invention comprising of a mouse body 1, a cord 2, and a connector 3.

A first positioning portion 11 is disposed at the rear side of the bottom surface of the mouse body 1. The first positioning portion 11 is a locking groove. The mouse body 1 has a receiving groove 12 annularly on the lateral surface thereof.

The cord 2 extends from the mouse body 1. The other distal end of the cord is connected with the connector 3.

The connector 3 corresponds to a computer, and can be a USB connector. A second positioning portion 31 corresponding to the first positioning portion 11 is disposed on the bottom surface of the connector 3. The second positioning portion 31 is a sliding piece, and is exactly locked with the first positioning portion 11 to position the connector 3 on the bottom surface of the mouse body 1.

As shown in FIGS. 1 and 2, when a user finishes using the mouse and disconnects the connector 3 from a socket of a computer, he or she can first wind the cord 2 along the receiving groove 12 annularly 1 to store the cord 2 in the receiving groove 12 on the lateral surface of the mouse body and also reduce the distance between the main body 1 and the connector 3. Next, the user can slide the second positioning portion 31 on the bottom surface of the connector 3 into the first positioning portion 11 of the mouse body 1 to combine and position the connector 3 on the bottom surface of the mouse body 1. The mouse body 1 and the connector 3 at both ends of the cord 2 can thus be combined together so that the user can conveniently carry the mouse (e.g., arbitrarily place it in a coat pocket) or receive the mouse in a storage space.

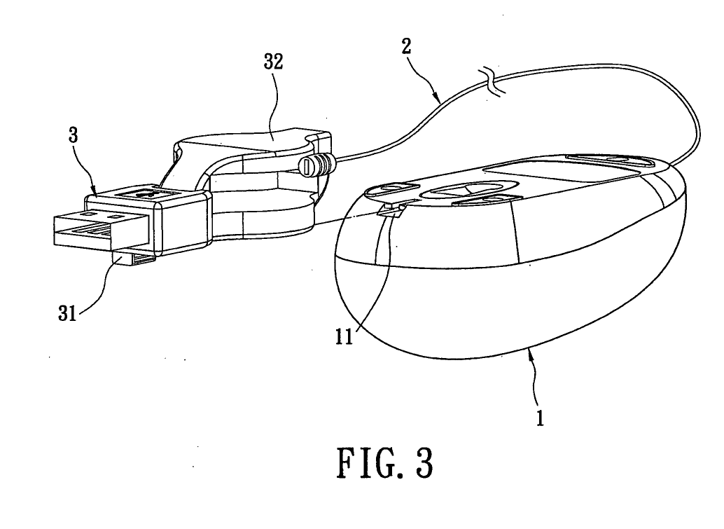

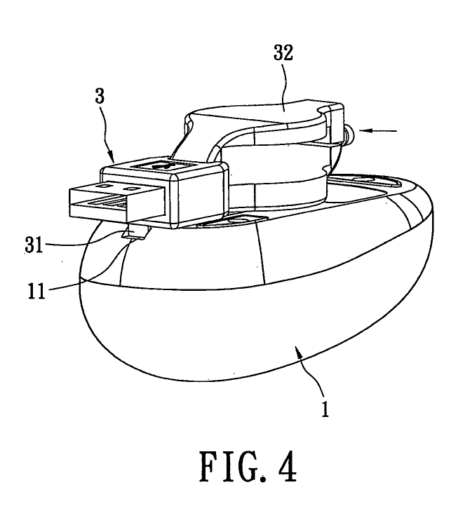

FIGS. 3 and 4 show a second embodiment of the present invention. A reel 32 is disposed at the rear end of the connector 3, and the distal end of the cord 2 is fixed in the reel 32.

When a user finishes using the mouse, the reel 32 can be used to quickly wind up and store the cord 2 in the reel 32 and simultaneously reduce the distance between the mouse body 1 and the connector 3.

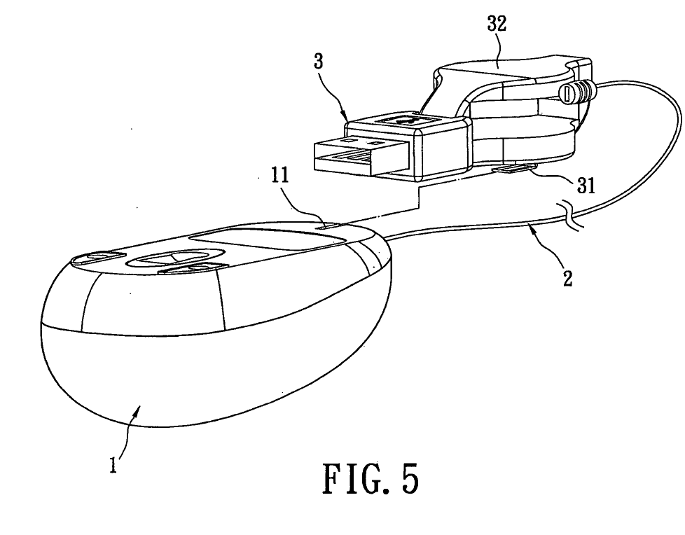

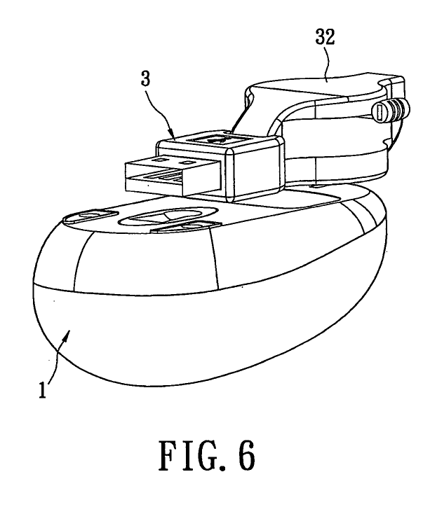

FIGS. 5 and 6 show a third embodiment of the present invention. The second positioning portion 31 can be disposed at the bottom of the reel 32, and the first positioning portion 11 is disposed at the front side of the bottom surface of the mouse body 1.

When a user finishes using a mouse, the cord 2 can be stored in the reel 32, and the second positioning portion 31 can be locked in the first positioning portion 11 of the mouse body 1 to combine and position the reel 32 and the connector 3 on the bottom surface of the mouse body 1. The mouse body 1 and the connector 3 at both ends of the cord 2 can thus be combined together so that the user can conveniently carry the mouse or receive the mouse in a storage space.

To sum up, the present invention has the following advantages:
1. The present invention makes use of the corresponding combination of the first positioning portion 11 and the second positioning portion 31 to combine the mouse body 1 and the connector 3 at both ends of the cord 2 together so as to reduce the space occupied by the mouse when not in use and also facilitate the portability and storage of the mouse.
2. A reel 32 can further be disposed at the rear end of the connector 3 to quickly wind up the cord 2 so as to shorten the whole time for storage.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mouse having a receiving and positioning structure comprising:
a mouse body having a first positioning portion on a surface thereof;
a cord extending from the main body; and
a connector disposed at a distal end of said cord, a second positioning portion corresponding to the first positioning portion being disposed on a surface of said connector;
whereby the first positioning portion of the mouse body and the second positioning portion of the connector are correspondingly combined together to position the connection on the surface of the mouse body.

2. The mouse as claimed in claim 1, wherein a receiving groove is annularly disposed on a lateral surface of the mouse body to receive the cord being wound up.

3. The mouse as claimed in claim 1, wherein a reel is disposed at a rear end of the connector, the distal end of the cord is fixed inside the reel, and the reel is used to wind the cord.

4. The mouse as claimed in claim 3, wherein the second positioning portion is disposed at a bottom of the reel.

5. The mouse as claimed in claim 1, wherein the first positioning portion is a locking groove, and the second positioning portion is a sliding piece corresponding to the first positioning portion.

6. The mouse as claimed in claim 1, wherein the first positioning portion is disposed at a bottom surface of the mouse body.

7. The mouse as claimed in claim 1, wherein the second positioning portion is disposed on a bottom surface of the connector.

8. The mouse as claimed in claim 1, wherein the connector is a USB connector.
